(19) United States
(12) Patent Application Publication
(10) Pub. No.: US 2024/0025699 A1
(43) Pub. Date: Jan. 25, 2024

(54) ELEVATOR CONTROLLER, ELEVATOR SYSTEM, STORAGE MEDIUM, AND MOBILE TERMINAL

(71) Applicant: Mitsubishi Electric Corporation, Tokyo (JP)

(72) Inventor: Yuya OTSUKI, Tokyo (JP)

(73) Assignee: Mitsubishi Electric Corporation, Tokyo (JP)

(21) Appl. No.: 18/025,924

(22) PCT Filed: Dec. 25, 2020
(86) PCT No.: PCT/JP2020/048767

§ 371 Date: Mar. 13, 2023

(51) Int. Cl. B66B 3/00; B66B 1/34; B66B 1/46

(52) U.S. Cl. CPC B66B 3/006; B66B 1/3461; B66B 1/468; B66B 2201/4653; B66B 2201/103; B66B 2201/4615; B66B 2201/4638; H04M 1/72412

(57) ABSTRACT

An elevator controller according to the present disclosure includes: a communication unit that receives, from a mobile terminal, signals each including information about elevator halls; and a determination unit that makes a determination for guiding a user on a basis of the information about the elevator halls received by the communication unit. The communication unit receives, from the mobile terminal, a first signal including floor registration elevator hall information, and after that, receives, from the mobile terminal, a second signal including registered floor return elevator hall information. On a basis of the first signal and the second signal, the determination unit determines whether or not an elevator at a registered floor return elevator hall is an elevator that goes to a floor registration elevator hall and, when the elevator is the elevator that goes to the floor registration elevator hall, notifies the mobile terminal the determination result.

### FIELD

The present disclosure is related to an elevator controller, an elevator system, a program, and a mobile terminal.

### BACKGROUND

Conventionally, in large facilities and the like provided with a parking structure, when people move within the facility on an elevator, some people may forget, after long hours of parking, which parking floor was used for entering the facility and may take a long time to return to their own automobile.

To cope with those circumstances, an elevator that helps a user to return to the parking floor even in the case where he/she has forgotten the parking floor has been proposed, as disclosed in PTL 1, for example. The elevator reads identification information of a mobile terminal of the user and stores the identification information so as to be kept in association with floor information of the parking floor. When the user is to return to the parking floor, the elevator reads the identification information of the mobile terminal and subsequently registers a destination floor on the basis of the associated floor information.

### CITATION LIST

### Patent Literature

[PTL 1] JP 2013-001500 A

### SUMMARY

### Technical Problem

However, the elevator in PTL1 is configured so that, after the user boards the elevator, the identification information of the mobile terminal is read by a reading device in an elevator cage (hereinafter, “car”) and is brought into association with the floor information of the parking floor, so that when the user uses the elevator later, the destination floor is registered on the basis of the floor information associated with the identification information. With this configuration, even though the parking floor is registered as the destination floor, the user may head for an elevator hall different from an elevator hall that is intended (hereinafter, “intended elevator hall”). If the user uses an elevator therefrom, he/she will need to change elevators and ride another elevator that goes to the intended elevator hall, which will cause inconvenience for the user.

To solve the problem described above, it is an object of the present disclosure to provide an elevator controller that, in a facility provided with elevators, guides an elevator user to the elevator that goes to the intended elevator hall, so that the user can easily return to the intended elevator hall.

### Solution to Problem

An elevator controller according to the present disclosure is an elevator controller used in an elevator system that, in a building provided with a plurality of elevators, guides a user of the elevators to an elevator that goes to an intended elevator hall by using a mobile terminal carried around by the user, the elevator controller including: a communication unit that receives, from the mobile terminal, signals each including information about the elevator hall received by the mobile terminal from a wireless signal transmitted by a corresponding one of transmitters provided at the elevator hall; and a determination unit that makes a determination for guiding the user on a basis of the information about the elevator hall received by the communication unit, wherein the communication unit receives a first signal from the mobile terminal being set in a floor registration mode in which information is registered about a floor registration elevator hall which is an elevator hall provided on a floor used by the user, the first signal including floor registration elevator hall information received by the mobile terminal within a wireless signal area of the transmitter, after receiving the first signal, the communication unit receives a second signal from the mobile terminal being set in a registered floor return mode in which information is transmitted about a registered floor return elevator hall which is an elevator hall on a floor to be used by the user at a time of returning to the floor registration elevator hall, the second signal including registered floor return elevator hall information received by the mobile terminal within a wireless signal area of the transmitter provided at the registered floor return elevator hall, and on a basis of the first signal and the second signal, the determination unit determines whether or not an elevator at the registered floor return elevator hall is the elevator that goes to the floor registration elevator hall and, when the elevator at the registered floor return elevator hall is the elevator that goes to the floor registration elevator hall, notifies the mobile terminal that the elevator is the elevator that goes to the floor registration elevator hall.

### Advantageous Effects of Invention

The elevator controller according to the present disclosure makes it possible for the elevator user to easily return to the intended elevator hall.

### BRIEF DESCRIPTION OF DRAWINGS

FIG. 1 is a block diagram of an elevator system according to a first embodiment.

FIG. 2 is a block diagram of a modification of the elevator system according to the first embodiment.

FIG. 3 is a figure showing an example of the elevator system in a building.

FIG. 4 is an example of a screen of an application shown on a presentation unit of a mobile terminal in the elevator system according to the first embodiment.

FIG. 5 are examples of a notification screen of the application in the elevator system according to the first embodiment.

FIG. 6 is a flowchart showing processings in a floor registration mode of the elevator system according to the first embodiment.

FIG. 7 is a flowchart showing processings in a registered floor return mode of the elevator system according to the first embodiment.

FIG. 8 is a block diagram of an elevator system according to a second embodiment.

FIG. 9 is a flowchart showing processings in a floor registration mode of the elevator system according to the second embodiment.

FIG. 10 is a flowchart showing processings in a registered floor return mode of the elevator system according to the second embodiment.

FIG. 11 are figures showing exemplary configurations of a processing circuit of the elevator controller according to the first embodiment.

### DESCRIPTION OF EMBODIMENTS

The following will describe embodiments of the present disclosure with reference to the accompanying drawings. In the figures, the same or corresponding elements are referred to by using the same reference characters. Duplicate explanations will be simplified or omitted as appropriate. Further, the present disclosure is not limited to the embodiments described below.

### First Embodiment

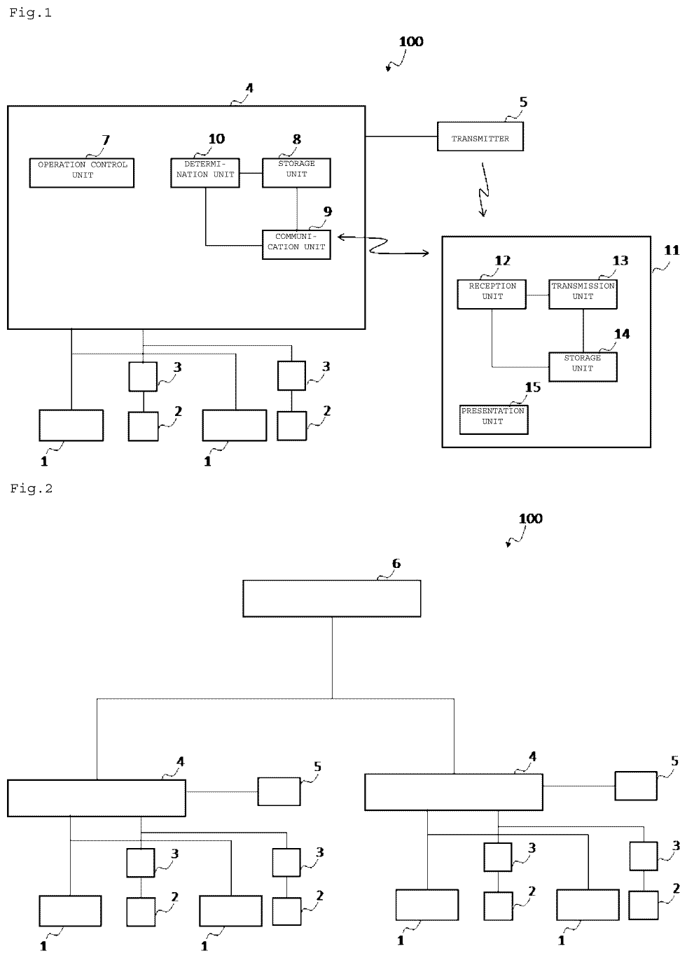

An elevator controller 4 according to a first embodiment will be explained, with reference to FIG. 1 and FIG. 2, on the basis of an elevator system 100.

FIG. 1 is a block diagram showing a configuration of the elevator system 100 according to the first embodiment. The elevator system 100 includes elevators 1, hall buttons 2, hall controllers 3, the elevator controller 4, and transmitters 5. The elevator system 100 is provided with the elevators 1 of which the quantity is two. Each of the elevators 1 is controlled by the elevator controller 4. However, the quantity of the elevators 1 is not limited to two. The elevators 1 may be provided in a larger quantity. Alternatively, as shown in FIG. 2, the elevator system 100 may be provided with multiple elevator controllers 4 each controlling multiple elevators 1 and may be provided with an elevator management device 6 that manages each of the elevator controllers 4. This configuration is similarly applicable to the other embodiments described later.

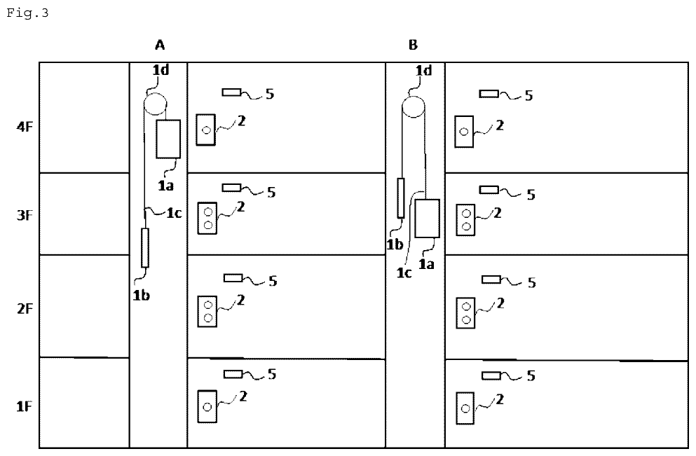

As shown in FIG. 3, the elevator system 100 according to the first embodiment is the elevator system 100 provided with the two elevators 1 (called A and B) in a building having four floors. However, possible configurations of the building are not limited to this example. Each of the elevators 1 is an elevator 1 that stops at each of the floors, namely, the first to the fourth floors, of the building. In correspondence with each of the elevators 1, the building is provided with four elevator halls on the first to the fourth floor of the buildings and is thus provided with eight elevator halls in total. Further, each of the elevator halls is provided with the hall button 2 and the transmitter 5. However, the transmitter 5 does not need to be provided at every elevator hall.

Next, in relation to the configuration of the elevator system 100, the elevators 1 will be explained. Each of the elevators 1 is provided with, for example, a car 1a and a counterweight 1b. The car 1a moves up and down in a shaft. The car 1a and the counterweight 1b are hung in the shaft by a main rope 1c. The main rope 1c is wound around a driving sheave 1d of a traction machine. The traction machine is controlled by the elevator controller 4. In other words, the elevator controller 4 controls the moving of the car 1a. The car 1a is provided with a car door. The elevator halls at which the car 1a stops are each provided with a hatch door. After causing the car 1a to stop at any one of the halls, the elevator controller 4 causes the car door to open and close. Further, the elevator controller 4 controls opening and closing of the hatch door in conjunction with the opening and closing of the car door. In this manner, the elevator controller 4 controls the elevators 1.

Further, each of the elevator halls is provided with the hall button 2. A user of an elevator 1 can make a hall call for the elevator 1, by operating the hall button 2. The hall button 2 is connected to the hall controller 3. The hall controller 3 transmits a signal that was input as a result of the operation performed on the hall button 2, to the elevator controller 4, so that the elevator 1 is controlled in response to the hall call for the elevator 1. Further, although not shown in the drawings, the car 1a is provided with a car button. By operating the car button, the user of the elevator 1 can input an intended floor. Upon receipt of the input through the car button, the elevator controller 4 controls operation of the elevator 1.

The elevator controller 4 includes an operation control unit 7, a storage unit 8, a communication unit 9, and a determination unit 10. The operation control unit 7 exercises a series of control related to operations of the elevators 1. The storage unit 8 stores therein, for example, information received from a mobile terminal 11 carried around by the user of the elevator 1. In this situation, the storage unit 8 does not need to be included in the elevator controller 4 and may be an external memory device or may be a server that communicates with the elevator controller 4 via the Internet lines.

The communication unit 9 has a function of communicating with the mobile terminal 11 carried around by the user of the elevator 1. The elevator controller 4 receives information from the mobile terminal 11 via the communication unit 9. Further, the elevator controller 4 transmits information to the outside, such as the mobile terminal 11, via the communication unit 9. In this situation, the communication unit 9 does not need to be included in the elevator controller 4 and may be an external communication device. The determination unit 10 makes a determination related to having the user guided by the elevator system 100, on the basis of the information received from the mobile terminal 11. Details of the determination unit 10 will be explained later.

Each of the transmitters 5 may be a beacon, for example, and transmits a wireless signal in a specific frequency band. Each of the transmitters 5 transmits the wireless signal in an area, which is the inside of a certain range. The transmitters 5 are provided in the halls at which the car 1a stops. The transmitters 5 may be provided at every hall at which the car 1a stops or may be provided at a certain number of halls.

Next, the information exchanged between the elevator controller 4 and the mobile terminal 11 will be explained. The mobile terminal 11 may be a smartphone, for example, and communicates with the elevator controller 4 by having a specific application (i.e., a program) installed therein. The mobile terminal 11 includes a reception unit 12, a transmission unit 13, a storage unit 14, and a presentation unit 15.

The reception unit 12 receives information from the wireless signals transmitted by the transmitters 5. Further, the reception unit 12 receives information from the communication unit 9 of the elevator controller 4. The transmission unit 13 transmits information to the elevator controller 4. The storage unit 14 stores therein the information received from the elevator controller 4 and from the transmitters 5.

In this situation, the mobile terminal 11 does not need to be a smartphone and may be a terminal received at the time of using the building. FIG. 4 is a figure showing an example of a screen of the application shown on a display serving as the presentation unit 15 of the mobile terminal 11. Through the application, the elevator user can select one from between a floor registration mode and a registered floor return mode. In other words, the floor registration mode and the registered floor return mode are implemented as a result of executing the program installed in the mobile terminal 11.

To begin with, the floor registration mode will be explained. The floor registration mode is a mode to be selected when the user who has arrived at the building starts being guided by the elevator system 100 at the time of using any of the elevators 1. The floor registration mode is set by floor registration mode setting means of the program.

In the floor registration mode, the mobile terminal 11 transmits first identification information identifying the mobile terminal 11 and hall information of the elevator 1 to be used by the elevator user, to the elevator controller 4. The hall information of the elevator 1 will be referred to as floor registration elevator hall information. As the first identification information, it is possible to use a unique identification number assigned to the mobile terminal 11, for example.

The floor registration elevator hall information is, for example, information including floor information of the transmitter 5 provided for the elevator and first position information indicating the position of the transmitter 5. In this situation, as the floor registration elevator hall information, it is also possible to use a unique identification number assigned to the transmitter 5 provided for the elevator. As for the identification information of the mobile terminal 11, the same applies to the description below.

When the floor registration mode is selected through the application, the mobile terminal 11 can communicate with the transmitter 5 that transmits the wireless signal. In other words, the mobile terminal 11 selected to be in the floor registration mode receives the wireless signal from the transmitter 5, upon entering the area of the wireless signal of the transmitter 5. The wireless signal is a signal including the floor registration elevator hall information, for example. In other words, the reception unit 12 of the mobile terminal 11 receives the floor registration elevator hall information. In this situation, the floor registration elevator hall information may be stored in the storage unit 14.

When the mobile terminal 11 selected to be in the floor registration mode receives the wireless signal including the floor registration elevator hall information from the transmitter 5, the mobile terminal 11 transmits a first signal including the first identification information and the floor registration elevator hall information, to the elevator controller 4. In other words, the transmission unit 13 of the mobile terminal 11 transmits the first signal to the elevator controller 4. The transmission of the first signal is carried out in response to the mobile terminal 11 receiving an instruction from first signal transmission instruction means of the program.

Upon receipt of the first signal from the mobile terminal 11, the elevator controller 4 stores the information included in the first signal into the storage unit 8. In this manner, by employing the mobile terminal 11, the elevator system 100 registers, into the elevator controller 4, the first identification information of the mobile terminal 11 and the hall information of the elevator 1 to be used by the elevator user. Further, by selecting an “END” option in the application, it is possible to end the floor registration mode.

Next, the registered floor return mode will be explained. The registered floor return mode is a mode to be selected when a building user starts being guided to the elevator 1 that returns to the elevator hall which was used upon his/her arrival at the building. The registered floor return mode is set by registered floor return mode setting means of the program.

In the registered floor return mode, the mobile terminal 11 transmits second identification information identifying the mobile terminal 11 and the hall information of the elevator 1 to be used by the elevator user, to the elevator controller 4. The hall information of the elevator 1 will be referred to as registered floor return elevator hall information.

The registered floor return elevator hall information is information including the floor information of the transmitter 5 provided for the elevator 1 and second position information indicating the position of the transmitter 5, for example. In this situation, as the registered floor return elevator hall information, it is also possible to use a unique identification number assigned to the transmitter 5 provided for the elevator 1.

When the registered floor return mode is selected through the application, the mobile terminal 11 can communicate with the transmitter 5 that transmits the wireless signal. In other words, the mobile terminal 11 selected to be in the registered floor return mode receives the wireless signal from the transmitter 5, upon entering the area of the wireless signal of the transmitter 5. The wireless signal is a signal including the registered floor return elevator hall information, for example. In other words, the reception unit 12 of the mobile terminal 11 receives the registered floor return elevator hall information. Further, the registered floor return elevator hall information may be stored in the storage unit 14.

When the mobile terminal 11 selected to be in the registered floor return mode receives the wireless signal including the registered floor return elevator hall information from the transmitter 5, the mobile terminal 11 transmits a second signal including the second identification information and the registered floor return elevator hall information, to the elevator controller 4. In other words, the transmission unit 13 of the mobile terminal 11 transmits the second signal to the elevator controller 4. The transmission of the second signal is carried out in response to the mobile terminal 11 receiving an instruction from second signal transmission instruction means of the program.

Upon receipt of the second signal from the mobile terminal 11, the elevator controller 4 stores the information included in the second signal into the storage unit 8. In this manner, by employing the mobile terminal 11, the elevator system 100 causes the elevator controller 4 to receive the second identification information of the mobile terminal 11 and the hall information of the elevator 1 to be used by the elevator user.

Upon receipt of the second identification information and the registered floor return elevator hall information, the elevator controller 4 determines whether or not the elevator 1 at the registered floor return elevator hall is the elevator 1 that goes to the floor registration elevator hall that was registered in the floor registration mode. This determination is made by the determination unit 10.

The determination unit 10 determines whether or not the second identification information included in the second signal matches the first identification information included in the first signal. When the first identification information matches the second identification information, the determination unit 10 determines whether or not the elevator at the registered floor return elevator hall is the elevator 1 that goes to the floor registration elevator hall that was registered in the floor registration mode.

The determination unit 10 makes the determination on the basis of, for example, whether or not the second position information included in the registered floor return elevator hall information matches the first position information included in the floor registration elevator hall information. When the first position information matches the second position information, it is determined that the elevator 1 at the registered floor return elevator hall is the elevator 1 that goes to the floor registration elevator hall that was registered in the floor registration mode. In this situation, when the identification information of the mobile terminal 11 included in the second signal does not match the identification information of the mobile terminal 11 included in the first signal, the determination unit 10 does not perform the process of determining whether or not the registered floor return elevator hall information is information about the hall of the elevator 1 that goes to the floor registration elevator hall. Further, when the registered floor return elevator hall information and the floor registration elevator hall information each include a unique identification number assigned to the transmitter 5, the determination unit 10 may make the determination on the basis of whether or not the unique identification numbers match each other.

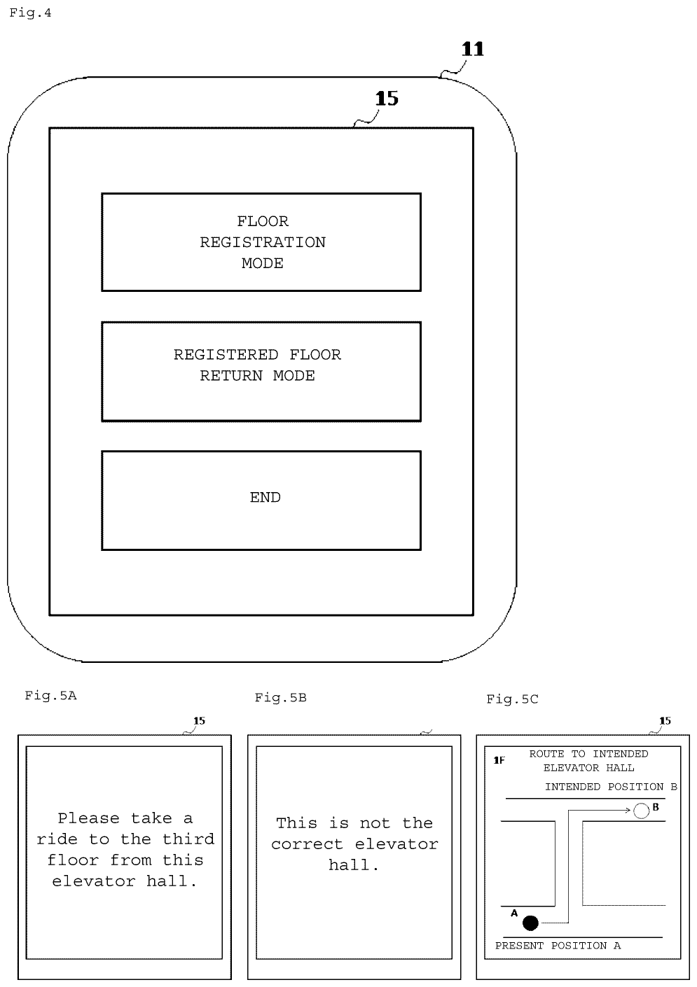

When the determination unit 10 determines that the elevator at the registered floor return elevator hall is the elevator 1 that goes to the floor registration elevator hall, the elevator controller 4 notifies the mobile terminal 11 that the elevator is the elevator 1 that goes to the intended elevator hall. In other words, the reception unit 12 of the mobile terminal 11 receives the notification about the result determined by the determination unit 10. When the mobile terminal 11 receives the notification, information providing means of the program provides information. As shown in FIG. 5a, for example, a notification such as “Please take a ride to the third floor from this elevator hall.” may be provided via the application.

As a result, by using the hall information of the elevator 1, the elevator controller 4 can guide the user of the elevator 1 carrying around the mobile terminal 11, to the elevator 1 that goes to the intended elevator hall.

On the contrary, when the determination unit 10 determines that the elevator at the registered floor return elevator hall is not the elevator 1 that goes to the floor registration elevator hall, the elevator controller 4 notifies the mobile terminal 11 that the elevator at the registered floor return elevator hall is not the elevator 1 that goes to the floor registration elevator hall. When the mobile terminal 11 receives the notification, the information providing means of the program provides information. As shown in FIG. 5b, for example, a notification such as “This is not the correct elevator hall.” may be provided via the application.

As a result, the user of the elevator 1 can avoid boarding, by mistake, the elevator 1 that does not go to the floor registration elevator hall. Further, by selecting the “END” option in the application subsequently, it is possible to end the registered floor return mode.

In another example, upon determining that the elevator 1 at the registered floor return elevator hall is not the elevator 1 that goes to the floor registration elevator hall, the determination unit 10 may provide a notification with information about the elevator hall of the elevator 1 that goes to the floor registration elevator hall. In the building shown in FIG. 3, when the hall of elevator B on the fourth floor is the floor registration elevator hall, if the registered floor return elevator hall is the hall of elevator A on the first floor, for example, a notification such as “Please go to the hall of elevator B on the first floor.” may be provided via the application.

As a result, the user of the elevator 1 can efficiently go to the elevator hall of the elevator that goes to the floor registration elevator hall.

Further, via the application, it is also acceptable to cause the mobile terminal 11 to show a route to the elevator 1 that goes to the floor registration elevator hall. FIG. 5c is an example of a figure showing a route to the elevator 1 that goes to the floor registration elevator hall. In FIG. 5c, the route to the elevator 1 that goes to the floor registration elevator hall is shown, via the application, on a display serving as the presentation unit 15 of the mobile terminal 11. As shown in FIG. 5c, the user carrying around the mobile terminal 11 can receive the notification about the route from point A representing the elevator hall at present, to point B indicating the elevator 1 that goes to the floor registration elevator hall, which is the intended elevator hall. As a result, the user of the elevator 1 can easily proceed to the intended elevator hall.

Further, when the determination unit 10 determines, on the basis of the first signal and the second signal, that the elevator at the registered floor return elevator hall is the elevator 1 that goes to the floor registration elevator hall, the elevator controller 4 may register a destination floor so as to arrange a ride to the floor registration elevator hall. This configuration enhances convenience for the user of the elevator 1.

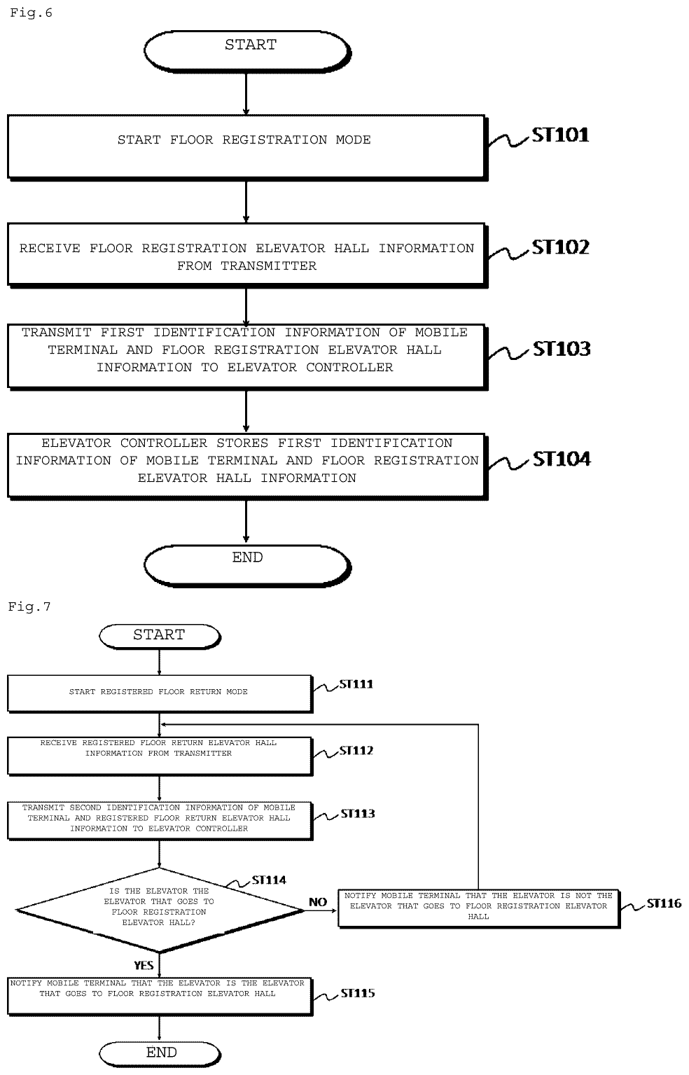

Next, processings of the elevator controller 4 in the first embodiment will be explained with reference to FIG. 6, on the basis of the elevator system 100.

FIG. 6 is a flowchart showing processings of the elevator system 100 according to the first embodiment. To begin with, processings in the floor registration mode will be explained. By using the application installed in the mobile terminal 11 which the user of the elevator 1 carries around, when the user turns the setting into the floor registration mode, the floor registration mode starts (ST101). While set in the floor registration mode, the mobile terminal 11 can receive the wireless signal in the wireless signal areas of the transmitters 5.

Subsequently, when the elevator user carrying around the mobile terminal 11 approaches the transmitter 5 at an elevator hall so that the mobile terminal 11 enters the wireless signal area, the mobile terminal 11 receives the floor registration elevator hall information from the transmitter 5 (ST102). The floor registration elevator hall information is the information including the floor information of the transmitter 5 provided at the hall of the elevator 1 used when the user arrived at the building and the first position information indicating the position of the transmitter 5.

Upon receipt of the floor registration elevator hall information from the transmitter 5, the mobile terminal 11 transmits the first signal including the first identification information of the mobile terminal 11 and the floor registration elevator hall information to the elevator controller 4 (ST103).

Upon receipt of the first signal from the mobile terminal 11, the elevator controller 4 stores the first identification information of the mobile terminal 11 and the floor registration elevator hall information into the storage unit 8 (ST104). The series of processings in the floor registration mode is thus completed.

Next, processings in the registered floor return mode will be explained, with reference to FIG. 7. By using the application installed in the mobile terminal 11 which the user of the elevator 1 carries around, when the user turns the setting into the registered floor return mode, the registered floor return mode starts (ST111). Subsequently, when the elevator user carrying around the mobile terminal 11 approaches the transmitter 5 at an elevator hall, so that the mobile terminal 11 enters the wireless signal area of the transmitter 5, the mobile terminal 11 receives the registered floor return elevator hall information from the transmitter 5 (ST112). The registered floor return elevator hall information is the information including the floor information of the transmitter 5 provided at the hall of the elevator 1 approached by the user who set the registered floor return mode and the second position information indicating the position of the transmitter 5.

Upon receipt of the registered floor return elevator hall information from the transmitter 5, the mobile terminal 11 transmits the second signal including the second identification information of the mobile terminal 11 and the registered floor return elevator hall information to the elevator controller 4 (ST113).

When the elevator controller 4 receives the second signal from the mobile terminal 11, the determination unit 10 determines whether or not the elevator is the elevator 1 that goes to the floor registration elevator hall (ST114). In this situation, the determination unit 10 makes the determination on the basis of whether or not the second position information included in the registered floor return elevator hall information matches the first position information included in the floor registration elevator hall information.

When the determination unit 10 determines that the elevator 1 at the registered floor return elevator hall is the elevator 1 that goes to the floor registration elevator hall (ST114: YES), the elevator controller 4 notifies the mobile terminal 11 via the application that the elevator is the elevator 1 that goes to the intended elevator hall (ST115). When the elevator controller 4 has notified the mobile terminal 11, the series of processings is thus completed.

When the determination unit 10 determines that the elevator 1 at the registered floor return elevator hall is not the elevator 1 that goes to the floor registration elevator hall (ST114: NO), the elevator controller 4 notifies the mobile terminal 11 via the application that the elevator is not the elevator 1 that goes to the floor registration elevator hall (ST116). Because the subsequent processings in ST112 and thereafter is the same, explanations thereof will be omitted.

As explained above, the elevator controller 4 according to the first embodiment is the elevator controller 4 that includes: the communication unit 9 that receives, from the mobile terminal 11, the signals each including information about a relevant one of the elevator halls received by the mobile terminal 11 from the wireless signal transmitted by the corresponding one of transmitters 5 provided at the elevator hall; and the determination unit 10 that makes the determination for guiding the user on the basis of the information about the elevator halls received by the communication unit 9. The communication unit receives the first signal from the mobile terminal being set in the floor registration mode in which the information is registered about the floor registration elevator hall which is the elevator hall provided on the floor used by the user, the first signal including the floor registration elevator hall information received by the mobile terminal within the wireless signal area of the transmitter. After receiving the first signal, the communication unit receives the second signal from the mobile terminal being set in the registered floor return mode in which the information is transmitted about the registered floor return elevator hall which is the elevator hall on the floor to be used by the user at the time of returning to the floor registration elevator hall, the second signal including the registered floor return elevator hall information received by the mobile terminal within the wireless signal area of the transmitter. On the basis of the first signal and the second signal, the determination unit determines whether or not the elevator at the registered floor return elevator hall is the elevator that goes to the floor registration elevator hall and, when the elevator is the elevator that goes to the floor registration elevator hall, notifies the mobile terminal that the elevator is the elevator that goes to the floor registration elevator hall.

With this configuration, the user of the elevator 1 can easily return to the intended elevator hall.

Further, in the elevator controller 4, when the determination unit 10 determines that the elevator 1 at the registered floor return elevator hall is not the elevator 1 that goes to the floor registration elevator hall, the elevator controller 4 provides the notification that the elevator is not the elevator 1 that goes to the floor registration elevator hall.

With this configuration, the user of the elevator 1 can avoid boarding, by mistake, the elevator 1 that does not go to the floor registration elevator hall.

Further, when the determination unit 10 determines that the elevator 1 at the registered floor return elevator hall is not the elevator 1 that goes to the floor registration elevator hall, the elevator controller 4 provides the notification including the information about the elevator hall of the elevator 1 that goes to the floor registration elevator hall.

With this configuration, the user of the elevator 1 can efficiently head for the elevator hall of the elevator that goes to the floor registration elevator hall.

Further, when the determination unit 10 determines that the elevator 1 at the registered floor return elevator hall is not the elevator 1 that goes to the floor registration elevator hall, the elevator controller 4 causes, via the application, the mobile terminal 11 to show the route to the elevator 1 that goes to the floor registration elevator hall.

With this configuration, the user of the elevator 1 can easily proceed to the intended elevator hall.

Further, when the determination unit 10 determines, on the basis of the first signal and the second signal, that the elevator at the registered floor return elevator hall is the elevator 1 that goes to the floor registration elevator hall, the elevator controller 4 registers a destination floor so as to arrange a ride to the floor registration elevator hall.

This configuration enhances convenience for the user of the elevator 1.

### Second Embodiment

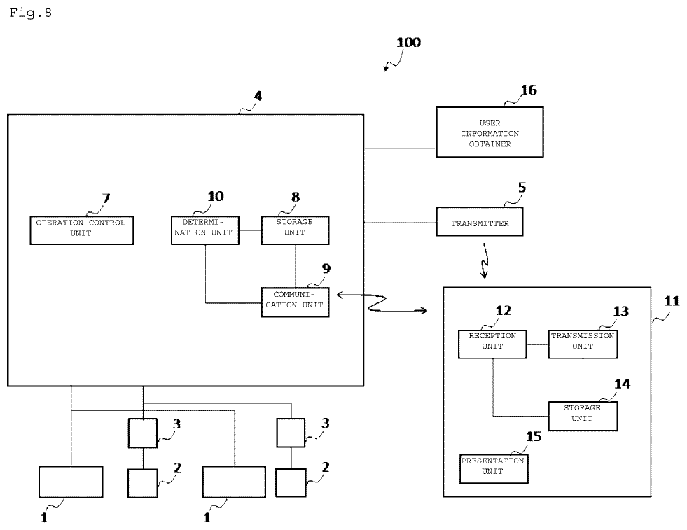

Next, the elevator controller 4 according to a second embodiment will be explained on the basis of the elevator system 100. FIG. 8 is a block diagram showing a configuration of the elevator system 100 according to the second embodiment. In the description below, certain configurations different from those in the first embodiment will primarily be explained. Explanations of the other configurations that are the same as those in the first embodiment will be omitted as appropriate. The elevator system 100 according to the second embodiment is different from the elevator system 100 of the first embodiment for including a user information obtainer 16.

The user information obtainer 16 obtains information for identifying the elevator user. The user information obtainer 16 may be, for example, a camera provided in the elevator hall. By employing an image sensor, the camera can obtain an image of the user at the elevator hall. As for the location of the camera, the camera may be installed on the ceiling of the elevator hall so as to be able to image a large area of the elevator hall or may be installed in the vicinity of an operating panel of the elevator 1 so as to be able to take the image of the elevator user in a straight-on direction. The user information obtainer 16 does not need to be a camera. It is also possible to use, as the user information obtainer 16, a fingerprint authentication device that reads fingerprint information of the elevator user, or the like.

The camera serving as the user information obtainer 16 is connected to the elevator controller 4. The camera can transmit image information of the elevator user that was taken to the elevator controller 4. The camera may be connected to the elevator controller 4 in a wired manner or may be connected via wireless communication. Further, the camera may be configured to be able to communicate with the transmitters at the elevator halls or with the mobile terminal 11. Furthermore, the camera may be provided with a function of processing the taken image. In that situation, the camera obtains the image information of the user by processing the image.

Next, features of the floor registration mode that are different from those in the first embodiment will primarily be explained. In the floor registration mode, when the first identification information identifying the mobile terminal 11 and the hall information (the floor registration elevator hall information) of the elevator 1 to be used by the elevator user are transmitted to the elevator controller 4, the elevator controller 4 controls the user information obtainer 16 so as to obtain first user information from the elevator user. The first user information is, for example, the image information of the elevator user taken by the camera. The first user information is information for identifying the elevator user.

The first user information is transmitted from the elevator controller 4 to the mobile terminal 11 and is stored in the storage unit 14 of the mobile terminal 11. It is also acceptable to store the first user information in the elevator controller 4. In other examples, the first user information may be directly transmitted from the user information obtainer 16 to the mobile terminal 11 or may be stored in the elevator controller 4 without being transmitted to the mobile terminal 11.

Next, features of the registered floor return mode that are different from those in the first embodiment will primarily be explained. In the registered floor return mode, when the second identification information identifying the mobile terminal 11 and the hall information (the registered floor return elevator hall information) of the elevator 1 to be used by the elevator user are transmitted to the elevator controller 4, the elevator controller 4 controls the user information obtainer 16 so as to obtain second user information from the elevator user. Similarly to the first user information, the second user information is image information of the elevator user taken by the camera, for example. The second user information is information for identifying the elevator user.

When the determination unit 10 receives the second identification information and the registered floor return elevator hall information, the elevator controller 4 determines whether or not the elevator 1 at the registered floor return elevator hall is the elevator 1 that goes to the floor registration elevator hall registered in the floor registration mode, which is the same operation as that in the first embodiment.

Subsequently, when the determination unit 10 determines that the elevator 1 at the registered floor return elevator hall is the elevator 1 that goes to the floor registration elevator hall, the elevator controller 4 notifies the mobile terminal 11 via the application that the elevator is the elevator 1 that goes to the intended elevator hall.

Further, on the basis of the first user information and the second user information, the determination unit 10 registers a destination floor. For example, the determination unit 10 makes a determination on the basis of whether or not the first user information matches the second user information. When the determination unit 10 determines that the first user information matches the second user information, the elevator controller 4 registers the destination floor so as to arrange a ride to the floor registration elevator hall. In this situation, the registration of the destination floor to arrange the ride to the floor registration elevator hall may be carried out, on the basis of determining whether or not the first identification information matches the second identification information or on the basis of determining whether or not both the pieces of identification information and the pieces of user information match. In this situation, the determination as to whether or not the first user information matches the second user information also includes the situation where pieces of data included in the pieces of user information do not completely match each other, such as when the elevator users are determined to match on the basis of pieces of image information, like in the situation where pieces of image information of the elevator user are used, for example. On the basis of the registration of the destination floor, the operation control unit 7 carries out operations of the elevator 1 by controlling the car 1a.

As explained above, because the user information is used for registering the destination floor so as to arrange the ride to the floor registration elevator hall, the user who used the floor registration elevator hall can return to the floor registration elevator hall without fail. Further, because the user information is used for registering the destination floor so as to arrange the ride to the floor registration elevator hall, the elevator user does not need to register the destination floor by touching the operating panel or the like.

Further, when the determination unit 10 determines that the first user information matches the second user information, the elevator controller 4 may notify the mobile terminal 11 of usage information of the user of the elevator 1. The usage information of the user of the elevator 1 may be, for example, time information of a time period from when the information about the floor registration elevator hall is registered, to when the information about the registered floor return elevator hall is transmitted. Alternatively, besides being the time information, the usage information may be parking fee information corresponding to the time period. Further, the usage information may be information including both the time information and the parking fee information.

As explained above, by receiving the notification with the usage information, because the user of the elevator 1 can learn the usage information such as the usage time period and/or the parking fee for himself/herself, convenience is enhanced.

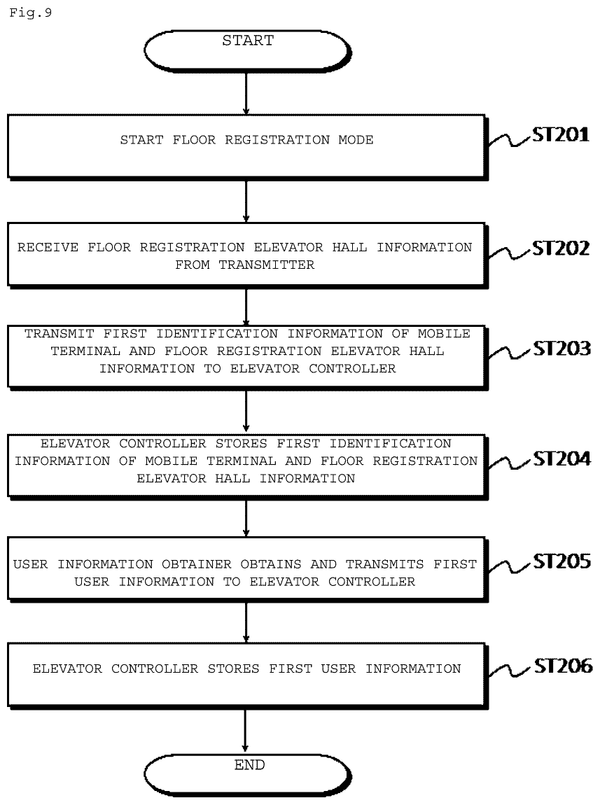

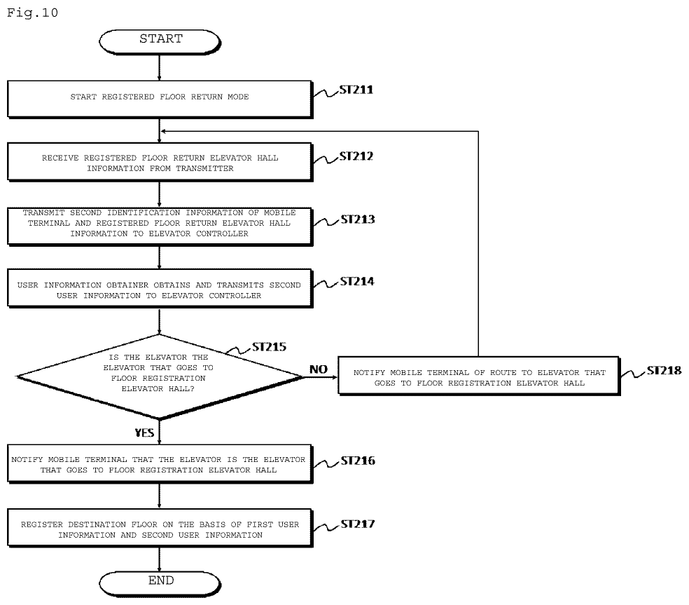

Next, processings of the elevator controller 4 according to the second embodiment will be explained with reference to FIG. 9 and FIG. 10, on the basis of the elevator system 100.

FIG. 9 is a flowchart showing processings of the elevator system 100 according to the second embodiment. To begin with, processings in the floor registration mode will be explained. In this situation, because the processings from ST201 through ST204 is the same as the processings from ST101 through ST104 in the first embodiment, explanations thereof will be omitted. After storing the first identification information of the mobile terminal 11 and the floor registration elevator hall information in the storage unit 8, the elevator controller 4 controls the user information obtainer 16 so as to obtain the first user information from the elevator user. The user information obtainer 16 transmits the first user information to the elevator controller 4 (ST205).

Upon receipt of the first user information from the user information obtainer 16, the elevator controller 4 stores the received first user information (ST206). The series of processings in the floor registration mode is thus completed. Alternatively, upon receipt of the first user information from the user information obtainer 16, the elevator controller 4 may transmit the first user information to the mobile terminal 11, so that the mobile terminal 11 stores therein the received first user information.

Next, processings in the registered floor return mode will be explained, with reference to FIG. 10. In this situation, because the processings from ST211 through ST213 and the processing in ST218 are the same as the processings from ST111 through ST113 and the processing in ST116 in the first embodiment, explanations thereof will be omitted. Upon receipt of the registered floor return elevator hall information from the transmitter 5, the mobile terminal 11 transmits, to the elevator controller 4, the second signal including the second identification information of the mobile terminal 11 and the registered floor return elevator hall information (ST213).

Upon receipt of the second signal from the mobile terminal 11, the elevator controller 4 controls the user information obtainer 16 so as to obtain the second user information from the elevator user and the user information obtainer 16 transmits the second user information to the elevator controller 4 (ST214). In this situation, the determination unit 10 makes a determination on the basis of whether the second position information included in the registered floor return elevator hall information matches the first position information included in the floor registration elevator hall information.

When the determination unit 10 determines that the elevator 1 at the registered floor return elevator hall is the elevator 1 that goes to the floor registration elevator hall (ST215: YES), the elevator controller 4 notifies the mobile terminal 11 via the application that the elevator is the elevator 1 that goes to the intended elevator hall (ST216).

Further, upon determining that the first user information matches the second user information, the determination unit 10 registers a destination floor so as to arrange a ride to the floor registration elevator hall (ST217). The series of processings in the registered floor return mode is thus completed.

As explained above, the elevator system 100 according to the second embodiment is the elevator system 100 further including the user information obtainer 16. Upon determination that the elevator 1 at the registered floor return elevator hall is the elevator 1 that goes to the floor registration elevator hall on the basis of whether or not the first signal matches the second signal, the determination unit 10 registers the destination floor so as to arrange the ride to the floor registration elevator hall on the basis of the first user information and the second user information. Thus, the car 1a is controlled on the basis of the registration of the destination floor.

With this configuration, the elevator system 100 registers the destination floor so as to arrange the ride to the floor registration elevator hall by using the user information. Consequently, convenience is enhanced for the elevator user, and also, the elevator user does not need to register the destination floor by touching the operating panel or the like.

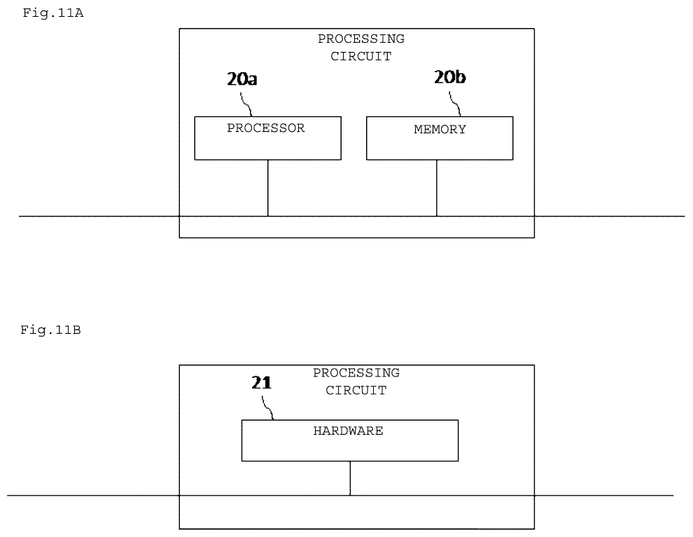

Next, an example of the elevator controller 4 will be explained with reference to FIG. 11. FIG. 11 are figures showing exemplary configurations of a processing circuit of the elevator controller 4 according to the first embodiment. In this situation, the exemplary configuration of the processing circuit of the elevator controller 4 also similarly applies to the second embodiment. Further, an exemplary configuration of a processing circuit of the mobile terminal 11 is also the same.

Various functions of the elevator controller 4 may be implemented by the processing circuit. For example, the processing circuit includes at least one processor 20a and at least one memory 20b. Further, for example, the processing circuit includes at least one piece of dedicated hardware 21.

When the processing circuit includes at least one processor 20a and at least one memory 20b, the various functions of the elevator controller 4 are implemented by software, firmware, or a combination of software and firmware. At least one of the software and the firmware is written as a program. At least one of the software and the firmware is stored in at least one memory 20b. At least one processor 20a implements the functions of the elevator controller 4, by reading and executing a program stored in at least one memory 20b. At least one processor 20a may be referred to as a Central Processing Unit (CPU), a central processing device, a processing device, an arithmetic operation device, a microprocessor, a microcomputer, or a DSP. For example, at least one memory 20b may be a non-volatile or volatile semiconductor memory such as a RAM, a ROM, a flash memory, an EPROM, or an EEPROM, or a magnetic disk, a flexible disk, an optical disk, a compact disk, a mini disk, a DVD, or the like.

When the processing circuit includes at least one piece of dedicated hardware 21, the processing circuit is implemented, for example, by a single circuit, a composite circuit, a programmed processor, parallel-programmed processors, an ASIC, an FPGA, or a combination of any of these. For example, each of the functions of the elevator controller 4 may be implemented by a different processing circuit. Alternatively, the functions of the elevator controller 4 may collectively be implemented by a processing circuit.

As for the functions of the elevator controller 4, while some functions may be implemented by the dedicated hardware 21, the other functions may be implemented by software or firmware.

As explained above, the processing circuit implements the functions of the elevator controller 4 by using the hardware 21, software, firmware, or a combination of any of these.

Embodiments of the present disclosure have thus been explained; however, the elevator controller 4, the elevator system 100, the program, and the mobile terminal 11 of the present disclosure are not limited to the embodiments described in the first embodiment and the second embodiment and merely represent a part of the scope of the present disclosure. The elevator controller 4, the elevator system 100, the program, and the mobile terminal 11 of the present disclosure may be combined with any of other publicly-known techniques. A part of the configurations thereof may be omitted or changed, by being combined as appropriate, for example, without departing from the gist of the present disclosure.

### REFERENCE SIGNS LIST

1 Elevator, 1a Car, 1b Counterweight, 1c Main rope, 1d Driving sheave, 2 Hall button, 3 Hall controller, 4 Elevator controller, 5 Transmitter, 6 Elevator management device, 7 Operation control unit, 8 Storage unit, 9 Communication unit, 10 Determination unit, 11 Mobile terminal, 12 Reception unit, 13 Transmission unit, 14 Storage unit, 15 Presentation unit, 16 User information obtainer, 20a Processor, 20b Memory, 21 Hardware, 100 Elevator system

1. An elevator controller used in an elevator system that, in a building provided with a plurality of elevators, guides a user of the elevators to an elevator that goes to an intended elevator hall by using a mobile terminal carried around by the user, the elevator controller comprising:
first processing circuitry
to receive, from the mobile terminal, signals each including information about the elevator hall received by the mobile terminal from a wireless signal transmitted by a corresponding one of transmitters provided at the elevator hall; and
to make a determination for guiding the user on a basis of the received information about the elevator hall, wherein
the first processing circuitry receives a first signal from the mobile terminal being set in a floor registration mode in which information is registered about a floor registration elevator hall which is an elevator hall provided on a floor used by the user, the first signal including floor registration elevator hall information received by the mobile terminal within a wireless signal area of the transmitter,
after receiving the first signal, the first processing circuitry receives a second signal from the mobile terminal being set in a registered floor return mode in which information is transmitted about a registered floor return elevator hall which is an elevator hall on a floor to be used by the user at a time of returning to the floor registration elevator hall, the second signal including registered floor return elevator hall information received by the mobile terminal within a wireless signal area of the transmitter provided at the registered floor return elevator hall, and
on a basis of the first signal and the second signal, the first processing circuitry determines whether or not an elevator at the registered floor return elevator hall is the elevator that goes to the floor registration elevator hall and, when the elevator at the registered floor return elevator hall is the elevator that goes to the floor registration elevator hall, notifies the mobile terminal that the elevator is the elevator that goes to the floor registration elevator hall.

2. The elevator controller according to claim 1, wherein
on the basis of the first signal and the second signal, the first processing circuitry determines whether or not the elevator at the registered floor return elevator hall is the elevator that goes to the floor registration elevator hall, and when the elevator is not the elevator that goes to the floor registration elevator hall, notifies the mobile terminal that the elevator is not the elevator that goes to the floor registration elevator hall.

3. The elevator controller according to claim 1, wherein
on the basis of the first signal and the second signal, the first processing circuitry determines whether or not the elevator at the registered floor return elevator hall is the elevator that goes to the floor registration elevator hall, and when the elevator is not the elevator that goes to the floor registration elevator hall, notifies the mobile terminal of the information about the elevator hall of the elevator that goes to the floor registration elevator hall.

4. The elevator controller according to claim 1, wherein
on the basis of the first signal and the second signal, the first processing circuitry determines whether or not the elevator at the registered floor return elevator hall is the elevator that goes to the floor registration elevator hall, and when the elevator is not the elevator that goes to the floor registration elevator hall, causes the mobile terminal to show a route to the elevator that goes to the floor registration elevator hall.

5. The elevator controller according to claim 1, wherein
the floor registration elevator hall information includes first position information indicating a position of the transmitter provided at the floor registration elevator hall,
the registered floor return elevator hall information includes second position information indicating a position of the transmitter provided at the registered floor return elevator hall, and
the first processing circuitry determines whether or not the elevator at the registered floor return elevator hall is the elevator that goes to the floor registration elevator hall, on a basis of whether or not the first position information matches the second position information.

6. The elevator controller according to claim 5, wherein
the first signal includes first identification information identifying the mobile terminal,
the second signal includes second identification information identifying the mobile terminal, and
when the first identification information matches the second identification information, the first processing circuitry makes the determination as to whether or not the first position information matches the second position information.

7. The elevator controller according to claim 1, wherein
when the first signal is transmitted from the mobile terminal to the elevator controller in the floor registration mode, the first processing circuitry obtains first user information identifying the user from a user information obtainer provided at the elevator hall,
when the second signal is transmitted from the mobile terminal to the elevator controller in the registered floor return mode, the first processing circuitry obtains second user information identifying the user from the user information obtainer, and
upon determining, on the basis of the first signal and the second signal, that the elevator at the registered floor return elevator hall is the elevator that goes to the floor registration elevator hall, the first processing circuitry makes a determination as to whether or not the first user information matches the second user information, and when the first user information is determined to match the second user information, registers a destination floor so as to arrange a ride to the floor registration elevator hall.

8. The elevator controller according to claim 7, wherein
upon determining that the first user information matches the second user information, the first processing circuitry notifies the mobile terminal of usage information of the user.

9. The elevator controller according to claim 1, wherein
upon determining, on the basis of the first signal and the second signal, that the elevator at the registered floor return elevator hall is the elevator that goes to the floor registration elevator hall, the first processing circuitry registers a destination floor so as to arrange a ride to the floor registration elevator hall.

10. An elevator system comprising:
the elevator controller according to claim 1; and
the transmitters that are provided at the elevator halls and that transmit the wireless signals received by the mobile terminal.

11. The elevator system according to claim 10, further comprising user information obtainers that are provided at the elevator halls and that obtain user information identifying the user, wherein
when the first signal is transmitted from the mobile terminal to the elevator controller in the floor registration mode, the communication unit obtains first user information identifying the user from the user information obtainer,
when the second signal is transmitted from the mobile terminal to the elevator controller in the registered floor return mode, the communication unit obtains second user information identifying the user from the user information obtainer, and
upon determining, on the basis of the first signal and the second signal, that the elevator at the registered floor return elevator hall is the elevator that goes to the floor registration elevator hall, the determination unit registers a destination floor so as to arrange a ride to the floor registration elevator hall on a basis of the first user information and the second user information.

12. A non-transitory storage medium storing a program that causes a computer to execute:
setting a floor registration mode in which information is registered about a floor registration elevator hall which is an elevator hall provided on a floor used by a user of elevators;
instructing a mobile terminal carried around by the user to transmit a first signal including floor registration elevator hall information received by the mobile terminal while in the floor registration mode and being positioned within a wireless signal area of a transmitter provided at the elevator hall;
setting a registered floor return mode in which, after the first signal is transmitted, information is registered about a registered floor return elevator hall which is the elevator hall on a floor to be used by the user at a time of returning to the floor registration elevator hall;
instructing the mobile terminal to transmit a second signal including registered floor return elevator hall information received by the mobile terminal while in the registered floor return mode and being positioned within a wireless signal area of a transmitter provided at the elevator hall; and
providing information about a result of determining, on a basis of the first signal and the second signal, whether or not an elevator at the registered floor return elevator hall is the elevator that goes to the floor registration elevator hall.

13. A mobile terminal equipped with the storage medium according to claim 12 in which the program stored the storage medium is installed, comprising:
second processing circuitry
to receive the floor registration elevator hall information received while in the floor registration mode and being positioned within the wireless signal area of the transmitter provided at the elevator hall, and the registered floor return elevator hall information received while in the registered floor return mode and being positioned within the wireless signal area of the transmitter provided at the elevator hall,
to transmit, according to the program, the first signal upon receipt of the instruction to transmit the first signal including the floor registration elevator hall information, and
to transmit, according to the program, the second signal upon receipt of the instruction to transmit the second signal including the registered floor return elevator hall information, wherein
the second processing circuitry receives a result of determining, on a basis of the first signal and the second signal, whether or not the elevator at the registered floor return elevator hall is the elevator that goes to the floor registration elevator hall.
